(19) United States
(12) Patent Application Publication
(10) Pub. No.: US 2009/0200844 A1
(43) Pub. Date: Aug. 13, 2009

(54) Children's Swing Cover with Mesh Panels

(76) Inventor: Pamela M. Tibaldo, Athens, AL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/029,713

(22) Filed: Feb. 12, 2008

(51) Int. Cl. A47D 15/00; A63G 9/00; A62B 35/00

(52) U.S. Cl. 297/219.12; 472/118; 297/468

(57) ABSTRACT

Disclosed a cover for an infant seat. The cover includes mesh panels that provide for improved air flow and which serve to keep an infant's back cool and ventilated. The cover is removable and machine washable. The various features of the present invention are described in greater detail hereinafter.

### CROSS-REFERENCE TO RELATED APPLICATIONS

This application claims priority to co-pending provisional patent application entitled “Children's Swing Cover with Mesh Panels” filed on Feb. 16, 2007 under application Ser. No. 60/901,977. The contents of this co-pending application are incorporated herein by reference.

### BACKGROUND OF THE INVENTION

1. Field of the Invention

This invention relates to a children's swing cover. More particularly, the present invention relates to a children's swing cover with one or more mesh panels to improve airflow.

2. Description of the Background

The use of infant swings is well known in the background art. These swings assist in automatically or manually rocking an infant for the purpose of soothing the child and facilitating sleep. Infant rockers come in various configurations, but a well known construction includes an inverted v-shaped frame beneath which a seat is suspended. The seat is adapted to swing forwardly and rearwardly relative to the frame and can include an electric motor for powering the rocking action. If desired, toys can be suspended from the top of the frame and a music player can also be incorporated for the purpose of producing a pleasing and sleep inducing environment for the infant.

As most parents are all too well aware, infants often spit up and/or drool. These tendencies can be exacerbated by movements, such as the movement of the child in a rocker. Accordingly, most rockers include seats that are covered in a stain resistant plastic, such as vinyl. These materials make the seat easy to clean in the event the child spits up. The problem with stain resistant materials, however, is that they are not breathable. Namely, what makes plastic easy to clean is that it is non-porous and, therefore, repels fluids. This same characteristic limits air flow to the back of an infant sitting in the seat. The non porous nature of most seats likewise means that perspiration from the infant's back is not absorbed. As a result, children who are placed in swinging seats often get warm and damp. All of this, of course, is counter productive to soothing a child to sleep.

### SUMMARY OF THE INVENTION

It is therefore one of the objectives of this invention to provide a cover for a child seat that includes breathable mesh panels to improve airflow.

It is another objective of this invention to provide a removable with large portions that are formed from a mesh fabric to improve ventilation.

It is yet another objective of this invention to provide a swing seat that can be easily removed from a child seat and which is machine washable.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a front view of the swing cover of the present invention.

FIG. 2 is a rear view of the swing cover of the present invention.

FIG. 3 is a side view of the swing cover of the present invention.

FIG. 4 is a view of the swing cover being positioned upon a seat frame.

FIG. 5 is a top view of the swing cover.

FIG. 6 is a bottom view of the swing cover.

Similar reference characters refer to similar parts throughout the several views of the drawings.

### DETAILED DESCRIPTION OF THE PREFERRED EMBODIMENT

The present invention relates to a cover for an infant seat. The cover includes mesh panels that provide for improved air flow and which serve to keep an infant's back cool and ventilated. The cover is removable and machine washable. The various features of the present invention are described in greater detail hereinafter.

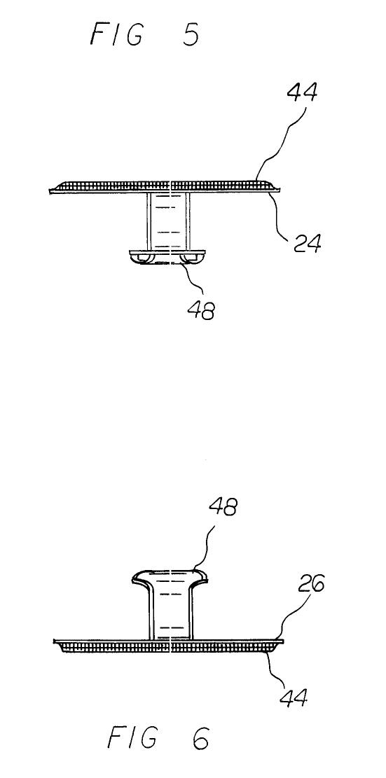

The cover 20 of the present invention is depicted in FIGS. 1-6. Although cover 20 is depicted and described as being used in conjunction with a swing seat, those skilled in the art will appreciate that cover 20 can be modified to accommodate other infant seats, such as high chairs or rockers. Nonetheless, the preferred cover 20 is specifically adapted for use in conjunction with a swing seat. In this regard, the cover can be employed with any of a variety of commercially available swings, such as the “Fisher-Prince Linkadoos Take Along Swing” or the “Fisher-Prince Infant Seat to Toddler Rocker.”

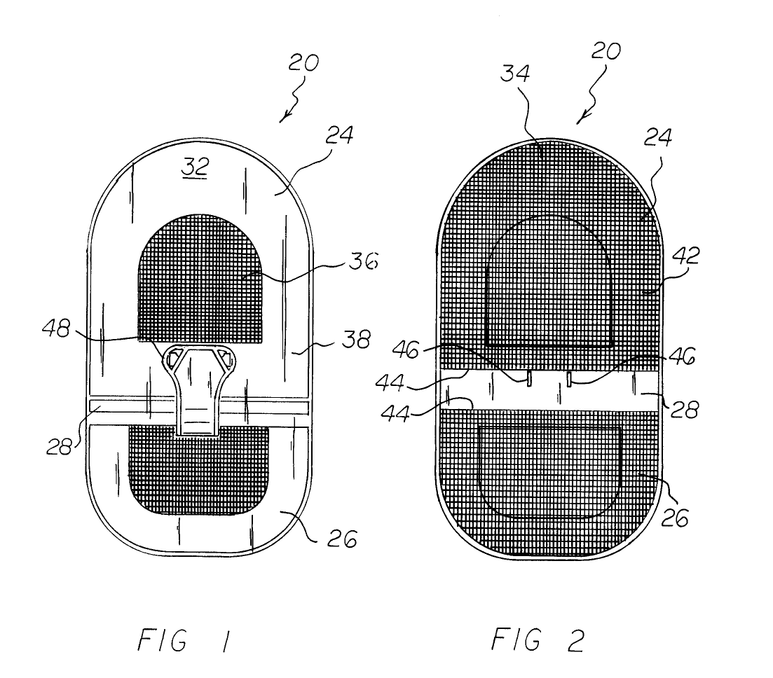

A description of cover 20 is next provided in connection with FIGS. 1 and 2 of the drawings. In the preferred embodiment, cover 20 is made from fabrics that are machine washable. This allows cover 20 to be easily removed and placed in a washing machine and/or dryer. As illustrated, cover 20 is integrally formed from upper and lower extents (24 and 26) that are interconnected along a crease 28. The entire cover 20 is made from a fabric material and is, therefore, foldable. Nonetheless, crease affords 28 even more flexibility and permits the upper and lower extents (24 and 26) to be folded on top of one another.

The upper and lower extents (24 and 26) are similar in construction and both include forward and rearward faces (32 and 34). Each forward face 32, in turn, includes an interior region 36 that is bounded by both a peripheral area 38 and the central crease 28. The peripheral area 38 is preferably formed from a cotton or cotton-blend material. If desired, the material can be treated with a stain resistant coating to improve cleanability.

The interior region 36 of each extent, however, is preferably formed from a Nylon mesh with 12 or more holes per inch. It has been found that Nylon with this mesh size provides excellent breathability and ventilation without sacrificing durability. Durability is important as premature wear could be hazardous to the infant sitting in the seat.

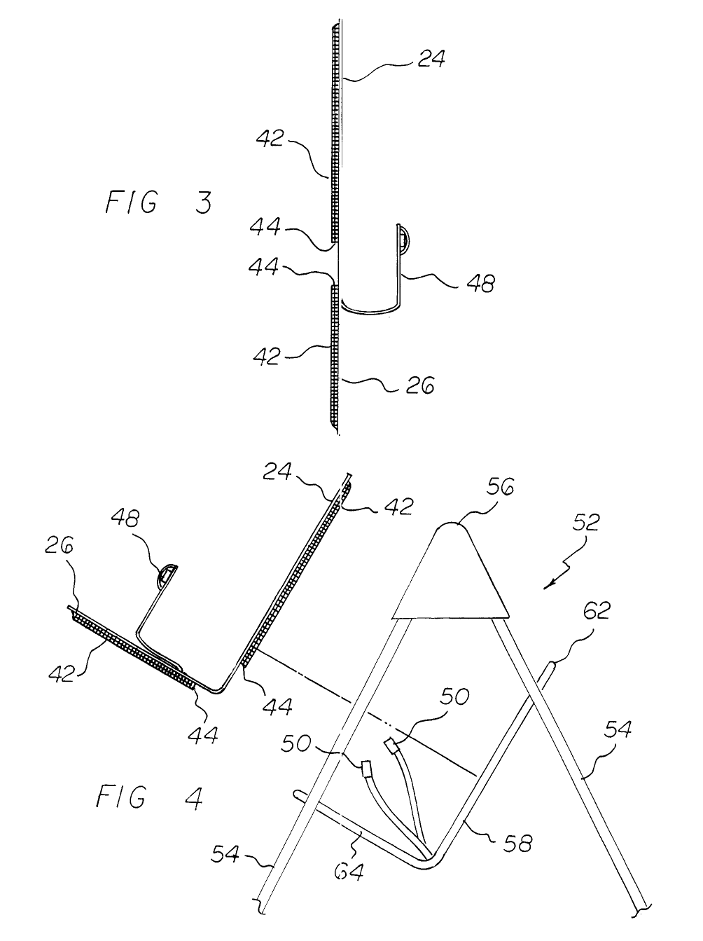

With reference now to FIGS. 2 and 3, the rearward faces 34 of the upper and lower extents (24 and 26) are described. In the preferred embodiment, the rearward faces 34 are entirely formed from a Nylon mesh with 12 or more holes per inch. Unlike the front face 32, wherein the mesh is an inset face 36, on the rear face 34 the mesh extends over the entire cover 20 and forms a pocket. Namely, the rear face 34 mesh is bounded at one end by the peripheral area 38 and further includes an open extent 44 adjacent crease 28. This allows the rearward face 34 of both the lower and upper extents (24 and 26) to be secured over a seat frame as depicted in FIG. 4. Additionally, one or more Velcro™ straps 46 are included for securing cover 20 to a seat frame.

A crotch strap 48 is also secured to crease 28 and extends from the forward face 32. Strap 48 is used to secure an infant to the swing. Namely, the frame may include one or more fastening straps 50 that can be passed through openings in cover 20. The distal ends of fastening straps 50 can include fasteners that are removably secured within mating fasteners within strap 48.

The swing 52 itself is depicted in FIG. 4 and includes a number of downwardly extending legs 54 as well as an overhead support 56. As will be appreciated, a seat frame 58 is suspended from the overhead support 56 to permit the seat frame 58 to rock forward or rearward relative to the legs 54. The seat frame 58 is formed from a back rest support frame 62 and a leg rest support frame 64. The cover 20 of the present invention is adapted to be removably secured over seat frame 58. This is accomplished by securing the rearward face 32 of the upper extent 24 over the backrest frame 62 and by further securing the rearward face 34 of the lower extent 26 over the leg rest frame 64. The Velcro™ fasteners 46 can then be used to secure the cover 20 in place. In this manner, ventilation is provided to the back of the infant by way of the mesh inserts 36.

Although Nylon mesh with 12 or more holes per inch has been described as preferred, those of ordinary skill in the art will appreciate other materials and mesh configurations that achieve the objects of the present invention.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A breathable seating system for improving: ventilation to the back of an infant, the system comprising:
a cover having upper and lower extents that are interconnected by a crease;
the upper extent of the cover having forward and rearward faces, the forward face have an interior region that is bounded by a peripheral area and the crease, the peripheral area being formed from a cotton material and the interior region being formed from a Nylon mesh with 12 or more holes per inch, the rearward face being entirely formed from a Nylon mesh with 12 or more holes per inch and being secured to the peripheral area, the rearward face having an opening along the crease;
the lower extent of the cover having forward and rearward faces, the forward face having an interior region that is bounded by a peripheral area and the crease, the peripheral area being formed from a cotton material and the interior region being formed from a Nylon mesh with 12 or more holes per inch, the rearward face being entirely formed from a Nylon mesh with 12 or more holes per inch and being secured to the peripheral area, the rearward face having an opening along the crease;
a crotch strap being secured to the crease and extending outwardly from the forward face, the strap being used to secure an infant to the swing seat;
an infant swing, the swing having a number of downwardly extending legs and an upper support, a seat frame suspended from the upper support such that the seat frame can rock forwardly and rearwardly relative to the legs, the seat frame including a back rest and a leg rest, the cover being removably secured to the seat frame by securing the rearward face of the upper extent over the back rest and by further securing the rearward face of the lower extent over the leg rest, whereby ventilation to the back of the infant is improved by way of the mesh inserts.

2. A breathable seating system comprising:
a cover having interconnected upper and lower extents;
the upper extent of the cover having forward and rearward faces, the forward face have an interior region that is bounded by a peripheral area, the interior region being formed from a mesh, a pocket formed on the rearward face;
the lower extent of the cover having forward and rearward faces, the forward face have an interior region that is bounded by a peripheral area, the interior region being formed from a mesh, a pocket formed on the rearward face;
an infant seat including a back rest and a leg rest, the cover being removably secured to the seat frame by securing the rearward face of the upper extent over the back rest and by further securing the rearward face of the lower extent over the leg rest, whereby ventilation to the back of the infant is improved by way of the mesh.

3. The cover as described in claim 2 wherein the mesh is formed from Nylon with 12 or more holes per inch.

4. The cover as described in claim 2 wherein the mesh is surrounded by a periphery made from a cotton material.

5. The cover as described in claim 2 wherein the upper and lower extents are interconnected by a crease.

6. The cover as described in claim 2 wherein a crotch strap is secured in between the upper and lower extents.

7. The cover as described in claim 2 wherein the cover is removably secured to a swing seat.

8. The cover as described in claim 2 wherein the pocket formed on the rearward faces of the upper and lower extents are formed from a Nylon mesh.

9. A breathable seating system comprising:
a cover having interconnected upper and lower extents;
the upper extent of the cover having forward and rearward faces, the forward face having at least one mesh panel, a pocket formed on the rearward face;
the lower extent of the cover having forward and rearward faces, the forward face having at least one mesh panel, a pocket formed on the rearward face;
an infant seat including a back rest and a leg rest, the cover being removably secured to the seat frame by securing the rearward face of the upper extent over the back rest and by further securing the rearward face of the lower extent over the leg rest, whereby ventilation to the back of the infant is improved by way of the mesh.
